(19) United States
(12) Patent Application Publication
(10) Pub. No.: US 2015/0157942 A1
(43) Pub. Date: Jun. 11, 2015

(54) SYSTEM, METHOD, AND STORAGE MEDIUM STORING A PROGRAM FOR PROVIDING ONLINE GAME ALLOWING EXCHANGE OF GAME ITEMS BETWEEN USERS

(71) Applicant: DeNA Co., Ltd., Tokyo (JP)

(72) Inventor: Osamu Ikeda, Tokyo (JP)

(21) Appl. No.: 14/558,500

(22) Filed: Dec. 2, 2014

(30) Foreign Application Priority Data
Dec. 9, 2013 (JP) 2013254082

(51) Int. Cl. A63F 13/79

(52) U.S. Cl. CPC A63F 13/79

(57) ABSTRACT

One object is to provide a game system restraining real money trade in a technical aspect. The game system includes one or more computer processors for executing a computer program to provide a game played by a plurality of users. The computer program includes: an exhibition request receiving module for receiving, from a first user among the plurality of users, an exhibition request for exhibiting a first game item owned by the first user; an exchange request receiving module for receiving, from a second user among the plurality of users, an exchange request for exchanging a second game item owned by the second user for the first game item exhibited by the first user; and a re-exhibition information presenting module for presenting, to part or all of the plurality of users, re-exhibition item information indicating that the second game item is exhibited for exchange for the first game item.

### CROSS-REFERENCE TO RELATED APPLICATIONS

This application is based on and claims the benefit of priority from Japanese Patent Application Serial No. 2013-254082 (filed on Dec. 9, 2013), the contents of which are hereby incorporated by reference in their entirety.

### TECHNICAL FIELD

The present invention relates to a system, method, and storage medium storing a program for providing online games allowing exchange of game items between users.

### BACKGROUND

There have been popular online games provided via a communication network to clients such as smartphones and cell phones. Such an online game is provided by a game server which processes game messages received from clients in accordance with predetermined game logic, returns the result of the processing to the clients, and provides various game data to the clients in accordance with progress of the game. Since the clients generate game screens based on the game data received from the server, the users can play the game by interacting with the game screens.

Online games may have built-in functions for exchange of game items such as electronic cards between users, so as to encourage social interaction between the users. One method of exchanging game items between users in an online game is discussed in Japanese Patent Application Publication No. 2009-187143 (the “'143 Publication”).

As discussed in the '143 Publication, some users sell and buy cards and items in real currency. Such a trade in real currency is called “real money trade” or RMT. If such real money trade is left uncontrolled, only part of users can play the game with an extremely advantageous condition, which may cause loss of game balance. In order to tackle this problem, online game providers prohibit real money trade in the user agreement and suspend play of the game for users who have violated the user agreement, thereby trying to restrain the real money trade.

However, even with strict application of such user agreement, there have been challenges to fully restrain real money trade. Therefore, various embodiments of the present invention provide a game system that restrains real money trade in a technical aspect.

### SUMMARY

One embodiment of the present invention relates to a system comprising one or more computer processors for executing a computer program to provide a game that can be played by a plurality of users. In an embodiment of the present invention, the computer program includes: an exhibition request receiving module configured to receive, from a first user among the plurality of users, an exhibition request for exhibiting a first game item owned by the first user; an exchange request receiving module configured to receive, from a second user among the plurality of users, an exchange request for exchanging a second game item owned by the second user for the first game item exhibited by the first user; and a re-exhibition information presenting module configured to present, to part or all of the plurality of users, re-exhibition item information indicating that the second game item is exhibited for exchange for the first game item.

Thus, an exchange may not be concluded upon receiving from the second user a certain exchange request for exchanging the second game item for the first game item exhibited by the first user; and re-exhibition item information is presented to other users, whereby no exchange is concluded between the first user and the second user. The re-exhibition item information may indicate that the second game item is exhibited for exchange for the first game item. Thus, even if the first user and the second user previously agree on payment of money for exchange of the first game item and the second game item (that is, even if a real money trade is attempted), the exchange of the game items between the first user and the second user may not be concluded. Therefore, the agreement loses effectiveness; and as a result, the real money trade can be prevented.

The computer program in accordance with an embodiment of the present invention comprises an exchange module configured to perform, upon receiving from a third user among the plurality of users an exchange request for exchanging the first game item owned by the third user for the second game item presented by the re-exhibition information presenting module, an exchange of the second game item owned by the second user for the first game item owned by the third user. The exchange of the first game item and the second game item is performed between the second user and the third user, not between the first user and the second user. The second user, who has made an exchange request for exchanging his own second game item for the first game item of another user, can exchange his own second game item for the first game item as desired. This embodiment not merely prevents a real money trade, but concludes an exchange for an game item desired by the user. Thus, this embodiment both prevents a real money trade and concludes an exchange of game items as desired by the user.

In an embodiment of the present invention, the re-exhibition item information may be presented when, e.g., a rarity value of the second game item in the exchange request satisfies a predetermined condition (e.g., a rarity value of the second game item is greater than a predetermined value). In another embodiment of the present invention, the re-exhibition item information may be presented when the relationship between a rarity value of the first game item and a rarity value of the second game item in the exchange request satisfies a predetermined condition (e.g., the difference between a rarity value of the second game item and a rarity value of the first game item is greater than a predetermined value). Thus, when an exchange request designates a game item having a high rarity value and difficult to obtain (e.g., the second game item) as an exchangeable game item, and when the game items to be exchanged have largely different values (rarity values), a new exhibition request may be automatically generated designating the second game item as an exhibited game item (re-exhibition item information may be presented), thereby to prevent conclusion of an exchange of the game items based on the exchange request. An exchange request designating an exchangeable game item having a high rarity value or designating game items to be exchanged having largely different rarity values may probably be related to a real money trade. Therefore, the above embodiment can effectively restrict a real money trade.

In an embodiment of the present invention, re-exhibition information may be presented to users other than the first user. Thus, a real money trade between the first user and the second user can be securely prevented.

A computer program according to an embodiment of the present invention may further include an exhibited item presenting module configured to present, to each of the plurality of users, exhibited item information on an exhibited game item exhibited by the other user. Further, the re-exhibition information presenting module according to an embodiment of the present invention may be configured to present the re-exhibition item information in priority to the exhibited item information. For example, in a search of exhibited game items, the re-exhibition item information may be displayed above the normal exhibited item information. Thus, since re-exhibition item information is presented to the user in priority to other exhibited item information, an exchange of the game item specified by the re-exhibition item information may be facilitated. The game items specified by the re-exhibition item information may probably be related to a real money trade. An exchange between users attempting a real money trade can be restricted by preferentially concluding an exchange for the game item specified by the re-exhibition item information.

As may be obvious from the above description, a system according to an embodiment of the present invention comprises one or more processors for executing the above and below described modules, thereby to function as a system comprising: an exhibition request receiving unit configured to receive, from a first user among the plurality of users, an exhibition request for exhibiting a first game item owned by the first user; an exchange request receiving unit configured to receive, from a second user among the plurality of users, an exchange request for exchanging a second game item owned by the second user for the first game item exhibited by the first user; a re-exhibition information presenting unit configured to present, to part or all of the plurality of users, re-exhibition item information indicating that the second game item is exhibited for exchange for the first game item; and units configured to perform other processes describe herein.

An embodiment of the present invention relates to a method of providing a game capable of being played by a plurality of users. The method according to an embodiment of the present invention comprises the steps of: receiving, from a first user among the plurality of users, an exhibition request for exhibiting a first game item owned by the first user; receiving, from a second user among the plurality of users, an exchange request for exchanging a second game item owned by the second user for the first game item exhibited by the first user; and presenting, to part or all of the plurality of users, re-exhibition item information indicating that the second game item is exhibited for exchange for the first game item.

As stated above, various embodiments of the present invention provide a game system that restrains real money trade in a technical aspect.

### BRIEF DESCRIPTION OF THE DRAWINGS

FIG. 1 is a block diagram schematically illustrating a system according to an embodiment of the present invention.

FIG. 2 shows an example of owned item management table used in a system according to the embodiment of the present invention.

FIG. 3 shows an example of exhibition request management table used in a system according to the embodiment of the present invention.

FIG. 4 shows an example of a search screen used in a system according to the embodiment of the present invention.

FIG. 5 shows an example of a search result of exhibited game items used in a system according to the embodiment of the present invention.

FIG. 6 shows an example of a search result of exhibited game items used in a system according to another embodiment of the present invention.

FIG. 7 shows an example of a selection screen of exchangeable game items used in a system according to the embodiment of the present invention.

FIG. 8 shows an example of exchange request management table used in a system according to the embodiment of the present invention.

FIG. 9 shows an example of display of re-exhibition item information used in a system according to the embodiment of the present invention.

FIG. 10 shows an example of exchange request management table used in a system according to the embodiment of the present invention.

FIG. 11 schematically shows a flow from exhibition of a game item through an exchange request for the exhibited game item and generation of re-exhibition item information finally to implementation of an exchange.

FIG. 12 is a flow diagram showing a flow of exchanging game items in accordance with an embodiment of the present invention.

### DESCRIPTION OF EXAMPLE EMBODIMENTS

Various embodiments of the present invention will be described hereinafter with reference to the drawings. In the drawings, the same components are denoted by the same reference numerals.

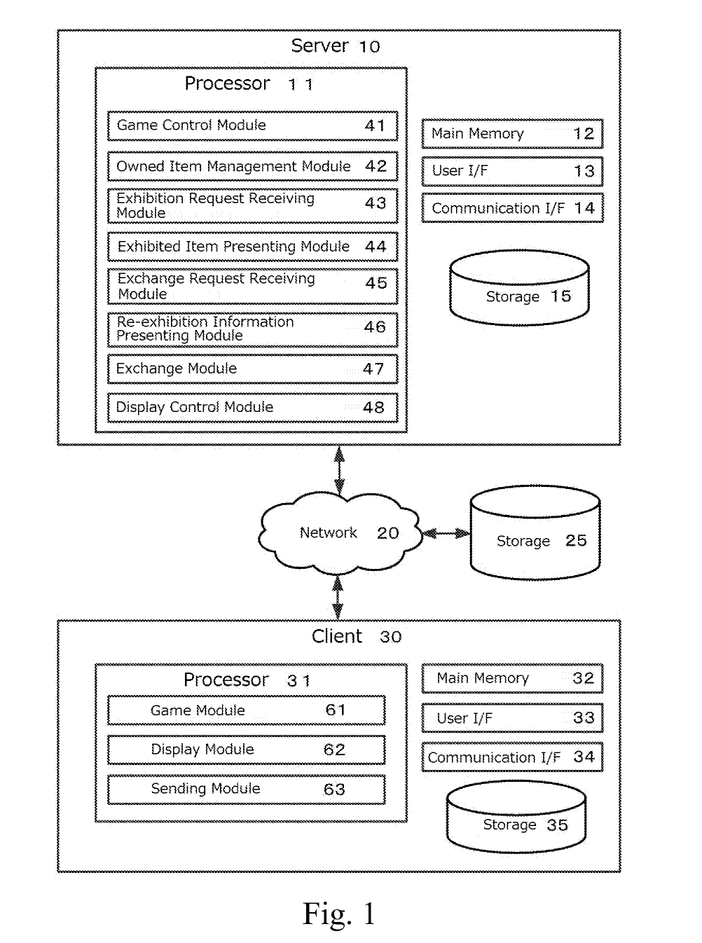

FIG. 1 is a block diagram schematically illustrating a system according to an embodiment of the present invention. As shown, the system according to an embodiment of the present invention may comprise a server 10 and a client 30.

In the embodiment shown in FIG. 1, the server 10 may be communicatively connected to the client 30 via a network 20 such as the Internet and provide the client 30 with an online game. For example, the server 10 may process a game message (e.g., a message related to operations of a user character or a message that a quest has been started) received from the client 30 in accordance with a predetermined game logic (or a program for implementing the game logic), and send a result of the process to the client 30. In this online game, users can use various game items. Game items applicable to the present invention will be described later. Although FIG. 1 shows only one client 30, the server 10 may be communicatively connected to a plurality of clients 30.

As shown, the server 10 may include a computer processor 11, a main memory 12, a user I/F 13, a communication I/F 14, and a storage 15. These components may be electrically connected to each other via a bus not shown. The processor 11 may load an operating system and various programs for implementing the game logic into the main memory 12 from the storage 15, and may execute commands included in the loaded programs. The main memory 12 may be used to store a program to be executed by the processor 11, and may be formed of, for example, a dynamic random access memory (DRAM).

The user I/F 13 may include, for example, an information input device such as a keyboard or a mouse for accepting an input from an operator, and an information output device such as a liquid crystal display for outputting calculation results of the processor 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the client 30 via the network 20.

The storage 15 may be formed of, for example, a magnetic disk drive and store various programs such as a game control program for implementing the game logic. The storage 15 may also store various data used in the game. The various data that may be stored in the storage 15 may also be stored on a database server communicatively connected to the server 10 and physically separate from the server 10.

The server 10 according to an embodiment of the present invention may be a web server for managing a web site including a plurality of hierarchical web pages. The client 30 may fetch HTML data for rendering these web pages from the server 10 and analyze the fetched HTML data to render a game screen on a display of the client 30. A user may provide various inputs to the client 30 via the game screen thereby to interact with a game provided by the server 10 (e.g., the user may operate a user object with instructions or select a menu). The HTML data for rendering a game screen to be provided to the client 30 may be stored on, e.g., the storage 15. The HTML data may be composed of HTML code written in a markup language such as HTML. The HTML code may be associated with various images. Additionally, the HTML data may include programs written in script languages such as ActionScript™ and JavaScript™.

Thus, the server 10 may manage the web site for providing game services and deliver web pages constituting the web site in response to a request from the client 30, thereby progressing the game. A game provided through such a web page is sometimes called a browser game.

The client 30 according to another embodiment of the present invention may be capable of executing a game application program in an execution environment such as an OS or middleware, such that the game application program and the server 10 may cooperate with each other to provide a game to the user. The game application programs may include, on execution on the client 30, instruction sets for processing game data provided by the server 10 and various data such as image data referred to when the instruction sets are executed. The game application programs may be created in, for example, object oriented languages such as Objective-C™ and Java™.

The game application program may be stored on, e.g., a storage 15, an external storage 25, or another storage not shown and delivered to the client 30 in response to a request from the client 30. The delivered game application programs may be received by the client 30 via a communication I/F 34 under the control by the processor 31. The received game application programs may be stored on, e.g., the storage 35. The application software may be launched in accordance with the user's operation on the client device 30 and may be executed on a platform, such as an OS or middleware, implemented on the client device 30. The server 10 may process messages from the game application programs in accordance with predetermined game logic and return various information indicating a result of the processing to the game application program, thereby to control the progress of the game.

Thus, the game application programs are executed on the client 30 such that the functions of the game application programs and the functions of the server 10 cooperate with each other to progress the game. A game provided through such game application programs is sometimes called an application game. The present invention can be applied to both browser games and application games.

The server 10 may also include a function to authenticate a user at start of the game and perform charging process in accordance with progression of the game. The games provided by the server 10 may include action games, role playing games, and baseball games. The types of the games provided by the system according to the present invention are not limited to those explicitly described herein but include any games allowing use of game items.

Next, the client 30 will be described below. The client 30 according to an embodiment of the present invention may be a desired information processing device including at least one of an execution environment of a browser game for rendering web pages of a game web site fetched from the server 10 on a web browser and an application execution environment for executing game application programs. Non-limiting examples of the client 30 may include mobile phones, smartphones, tablet terminals, personal computers, electronic book readers, wearable computers, and game consoles.

As shown, the client 30 according to an embodiment of the present invention may include a processor 31, a main memory 32, a user interface (I/F) 33, a communication I/F 34, and a storage 35, and these components may be electrically connected to one another via a bus 36.

The processor 31 may load various programs such as an operating system into the main memory 32 from the storage 35, and may execute commands included in the loaded programs. The main memory 32 may be used to store a program to be executed by the processor 31, and may be formed of, for example, a dynamic random access memory (DRAM).

The user I/F 33 may include an information input device for receiving inputs from the user and an information output device for outputting an operation result of the processor 31; and the user I/F 33 may include a display device such as a liquid crystal display having a touch screen. The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the server 10 via the network 20.

The storage 35 may comprise, for example, a magnetic disk drive or a flash memory and store various programs such as an operating system. When receiving a game application program from the server 10 via the communication I/F 34, the storage 35 may store the received game application program.

The client 30 may include, for example, browser software for interpreting an HTML file (HTML data) and rendering a screen; this browser software may enable the terminal device 30 to interpret the HTML data fetched from the server 10 and render web pages corresponding to the received HTML data. Further, the client 30 may include plug-in software (e.g., Flash Player distributed by Adobe Systems Incorporated) embedded into browser software; therefore, the terminal device 30 can fetch from the server 10 a SWF file embedded in HTML data and execute the SWF file by using the browser software and the plug-in software.

In the client 30, the game application program may be launched in accordance with the operation by the user and executed on a platform implemented on the client 30. When a game application program is executed on the client 30, for example, animation or an operation icon designated by the program may be displayed on a screen of the client 30. The user may enter an instruction for progressing the game through the user I/F 33 of the client 30.

The processor 11 of the server 10 and the processor 31 of the client 30 according to an embodiment of the present invention may execute various computer program modules. The computer program modules executed in the server 10 and the client 30 and other computer program modules as required may implement various functions of the system of the present invention.

As shown, computer program modules executed by the processor 11 of the server 10 may include a game control module 41, an owned item management module 42, exhibition request receiving module 43, exhibited item presenting module 44, exchange request receiving module 45, re-exhibition information presenting module 46, an exchange module 47, and a display control module 48. The computer program modules executed by the processor 31 of the client 30 may include a game module 61, display module 62, and a sending module 63.

A part or all of the modules shown in FIG. 1 in association with the processor 11 of the server 10 may also be executed by the processor 31 of the client 30 or a processor of any other device; and a part or all of the modules shown in association with the client 30 may also be executed by the processor 11 of the server 10 or a processor of any other device.

The modules executed on the server 10 will be further described below. For example, the game control module 41 according to an embodiment of the present invention may process a game message from the client 30 in accordance with predetermined game logic and provide various game data for executing an online game to the client 30, thereby to control the progress of the online game provided to the client 30. For example, when receiving from the client 30 an item use message for instructing a user character to use an item, the game control module 41 may perform a process of causing the user character to use the designated item, and may provide item use information (a sort of game data) indicating the result (e.g., recovery of life) to the client 30. The game data provided by the game control module 41 may include, for example, character data related to the user characters, object data related to the objects other than user characters, and quest data related to the quests experienced by the user. The game data may include various data in accordance with the types and properties of the games, in addition to the data described above. Also, the game control module 41 may provide a chat function and a messaging function to encourage communication between users.

The games provided by the server 10 according to an embodiment of the present invention may include so-called card games. In the card games, a user can use one or more his own cards to fulfill a mission or combat other users or non-user characters, thereby progressing the game. The Applicant has provided, on the Mobage™ platform, various card games (e.g., “Kaito Royale”) as browser games and game applications (native applications) for performing the card games.

The users can obtain and own various game items in accordance with progress of the game. The game items used in the present invention may include, for example, electronic cards used in the game, items related to equipment such as weapons and protectors used in the game and various other items, and avatars used in the game; and the game items used in the system according to the present invention are not limited thereto but may include any game items used in the game.

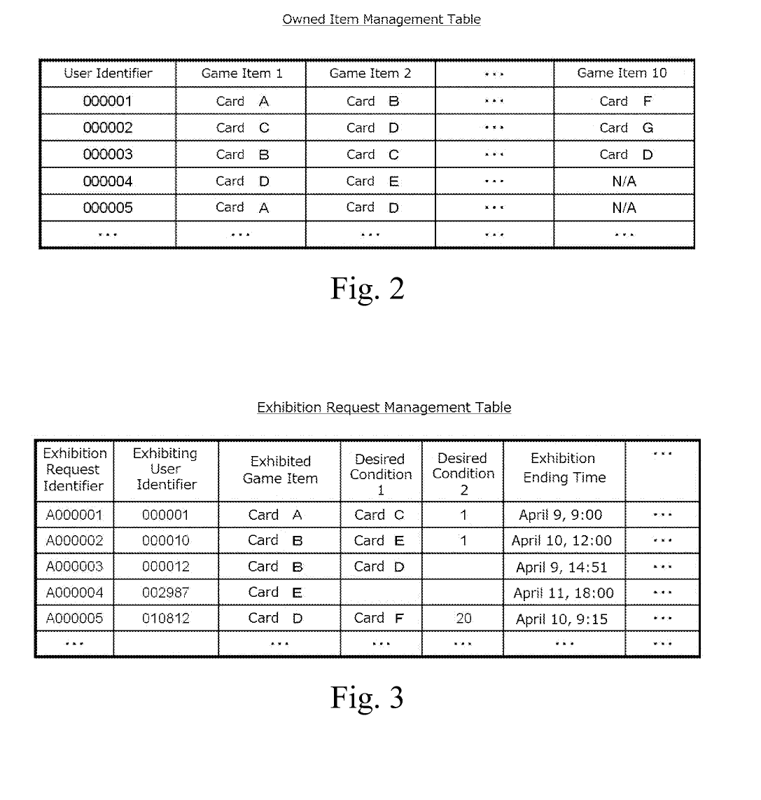

The game items owned by the users may be managed by, e.g., the owned item management table. The owned item management module 42 according to an embodiment of the present invention may use the owned item management table to manage the game items owned by the individual users of the online game provided by the server 10. FIG. 2 shows an example of owned item management table used in the embodiment of the present invention. As shown, the owned item management table may record game items owned by a user in association with the user identifier identifying the user. In an embodiment of the present invention, each of the game items owned by a user may have a game item identification number assigned thereto for identifying the game item; and the owned item management table may store the game item identification number identifying the game item owned by the user in association with the user identifier of the user. Additionally, if a user can own a plurality of same type of game items, the owned item management table may store owned number of the game items in association with the game item identifiers identifying the plurality of owned game items. FIG. 2 shows an example of the owned item management table wherein a user can own up to ten (types of) game items. The text “N/A” indicates that the number of the owned game items is less than ten.

When the user obtains a new game item, the owned item management module 42 according to an embodiment of the present invention may update the owned item management table by recording the obtained game item (or the game item identifier identifying the game item) in association with the user identifier of the user who obtained the game item. In an embodiment of the present invention, game items may be used in various aspects by the user in accordance with progress of the game; for example, they are obtained, owned, used, managed, exchanged, fused, reinforced, sold, abandoned, and/or presented in the game. The user may own various game items by obtaining, selling, and/or abandoning the game items. When a game item is owned by a different user through, e.g., an exchange of the game item, the owned item management module 42 may update the owned item management table so as to reflect the change of the owner of the game item.

The “user identifier” in the owned item management table may be an identification code identifying a user. The code system of the user identifier is not limited to that explicitly described in this specification or the drawings but may be any desired code system. The user identifier may be assigned to a user, e.g., when the user first logs in the game or when the user signs up for the game. Since the user repeatedly uses the same user identifier for later logins, the user identifier may be used in the game as an identifier specific to the user. The “game item identifier” may be an identification code identifying (the type of) a game item owned by the user. The code system of the game item identifier is not limited to that explicitly described in this specification or the drawings but may be any desired code system.

The game items have properties (e.g., “rarity,” “offense power,” “defense power,” and “game item name”) referred to on, e.g., battles with other user characters or non-user characters and on challenge for a quest. For example, the server 10 may manage various properties of the game items using the property management table (not shown). The property management table may store various properties of the game item such as the level, offense power, defense power, game item name, and images representing the game item, in association with the game item identifier of the game item. The properties of the game item are not limited to those explicitly described herein but may include various information indicating the features, qualities, values, and types of the game item. In an embodiment of the present invention, properties of a game item may include “variable properties” that may vary in accordance with progress of the game, and “constant properties” such as a name that may not vary in accordance with progress of the game. For example, “level,” “offense power,” “defense power,” and “mobility” may be variable properties that often vary in accordance with progress of the game. On the other hand, the “name” and “image” of a game item may be constant properties that may remain unchanged in progress of the game. Variable properties are not limited to those described herein but may include various information varying in accordance with progress of the game. Constant properties are also not limited to those described herein but may include various information not varying or substantially not varying in accordance with progress of the game.

The game items can be exchanged in the game. However, as stated above, money (real world currency) may unfavorably be paid in the real world for a game item provided in a game (real money trade). The embodiments of the present invention may provide various functions for preventing such real money trade related to game items. The functions and methods for preventing such real money trade will now be described in detail.

A user hoping to exchange his own game item for a game item owned by another user may first operate the client 30 to send an exhibition request to the server 10, the exhibition request designating the owned game item to be exchanged for the game item of the other user. The exhibition request may include various information such as a user identifier of the user making the exhibition request (hereinafter referred to as “exhibiting user”), a game item identifier of the game item to be exhibited (hereinafter referred to as “exhibited game item”), and information indicating a desired exchange condition. The desired exchange condition may specify, for example, the desired game item in exchange for the exhibited game item. For example, when user 1 exhibits his own card A to be exchanged for a card B owned by another user, the exhibition request from user 1 may include the user identifier of user 1 as an exhibitor, the game item identifier of the exhibited game item (card A), and the game item identifier of the desired game item (card B). The exhibition request may be sent to the server 10 from the client 30 of the exhibiting user.

The exchange condition specified by the exhibition request may include a condition other than the game item identifier identifying the desired game item. For example, the exchange condition may include the quantity of the desired game items, properties of the desired game items such as offense power, and other various conditions that can be set by the user. In an embodiment of the present invention, the exchange condition may be desirably inputted by the exhibiting user. For example, if a desired condition includes the number of desired game items, the exhibiting user can input a desired number such as 127. In another embodiment, the desired condition may be selected from a limited number of options presented by the game. For example, when the desired conditions include the number of game items, 10-increment options ranging from 10 to 200 such as “10,” “20,” . . . “200” are presented, and the exhibiting user selects one close to the desired condition from the limited number of options.

The exhibition request sent from the client 30 may be received by the exhibition request receiving module 43 in the server 10 according to an embodiment of the present invention. The exhibition request receiving module 43 according to an embodiment of the present invention may receive the exhibition request for exhibiting an owned game item from each of the plurality of users of the online game provided by the server 10. The exhibition request from the user may be managed by the exhibition request receiving module 43 using the exhibition request management table. FIG. 3 shows an example of exhibition request management table used in the embodiment of the present invention. As shown, the exhibition request management table may store the user identifier of an exhibiting user, an exhibited game item, a desired condition designated by the exhibiting user, and the duration of the exhibition request (exhibition period), for each exhibition request received by the exhibition request receiving unit 43. The desired condition may include, for example, the type and the number of desired game items to be exchanged for the exhibited game items; and in the exhibition request management table, the field of Desired Condition 1 may record the desired game item and the field of Desired Condition 2 may record the number of the desired game items. As to the exhibition period of the exhibition request, the exhibition request management table may also record the exhibition ending time at which the duration of the exhibition request is terminated. For example, the exhibition ending time may be set to 24 hours after the exhibition request is received from the exhibiting user.

In the example shown in FIG. 3, an exhibition request identifier for identifying the exhibition request may be generated when the exhibition request is received from the user, and information on the exhibition request may be stored in associated with the generated exhibition request identifier. For example, when an exhibition request is received from user 1, an exhibition request identifier “A000001” may be generated; and the exhibition request management table may store, in association with the exhibition request identifier “A000001,” information representing a user identifier “000001” of user 1 as the exhibiting user, an exhibited game item (card A) exhibited by user 1, a desired game item (card B) to be exchanged for the exhibited game item, the number of the desired game items (one), and the time when the exhibition of the exhibited game item is to be ended “April 9, 9:00.”

The exhibited item presenting module 44 according to an embodiment of the present invention may be configured to present, to the users, exhibited item information on the exhibited game items exhibited by the exhibiting user. For example, the exhibited item presentation module 44 may refer to the exhibition request management table to generate exhibited item information on the exhibited game item specified in the exhibition request, and provide the generated exhibited item information to the client 30 of the user, for each exhibition request received by the exhibition request receiving module 43. The “exhibited item information” of an exhibited game item may include various parameters such as a game item identifier identifying the exhibited game item, an image representing the exhibited game item, the name of the exhibited game item, and the level and offense power assigned to the exhibited game item. However, the “exhibited item information” is not limited to that explicitly described herein but may include various information indicating the features and characteristics of the exhibited game item. The client 30 may display in a screen the exhibited item information received from the server 10.

The exhibited item presenting module 44 according to an embodiment of the present invention can generate exhibited item information not including “user specifying information” that specifies the exhibiting user. The “user specifying information” on a user may be any information indicating characteristics and features of the user; and this information allows the user to be specified when presented to another user. The “user specifying information” may include, for example, a user identifier (user ID), a user name, and an avatar. A user name may be freely set by the user, and thus a plurality of users may have a same user name. In such a case, the user name does not uniquely specify a user. However, since the number of users actually interacting with each other in a game is limited, a user name may actually serve as a mark for specifying a user. Therefore, a user name may be herein included in user specifying information that specifies a user. An avatar may also be included in user specifying information for the same reason. That is, since many users use avatars having characteristic appearance, an avatar can help to specify a user although it does not necessarily specify a user uniquely. In addition to the above mentioned user identifier, user name, and avatar, the user specifying information may include various information generated in accordance with progress of the game. For example, the user specifying information may include an exhibition request identifier, which is generated based on an exhibition request and uniquely specifies an exhibiting user.

The exhibited item presenting module 44 according to an embodiment of the present invention may be configured to generate exhibited item information so as not to include the above mentioned variable properties among the properties of an exhibited game item. When the exhibited item information includes the variable properties, a user may communicate the variable properties (e.g., offense power) of the exhibited game item to another user by using the message function in the game, and the other user viewing the exhibited item information may specify the exhibiting user of the exhibited game item. Thus, the variable properties may possibly be used as a sign for real money trade. In an embodiment of the present invention, the exhibited item information may be generated so as not to include the variable properties, making it difficult to specify the exhibiting user.

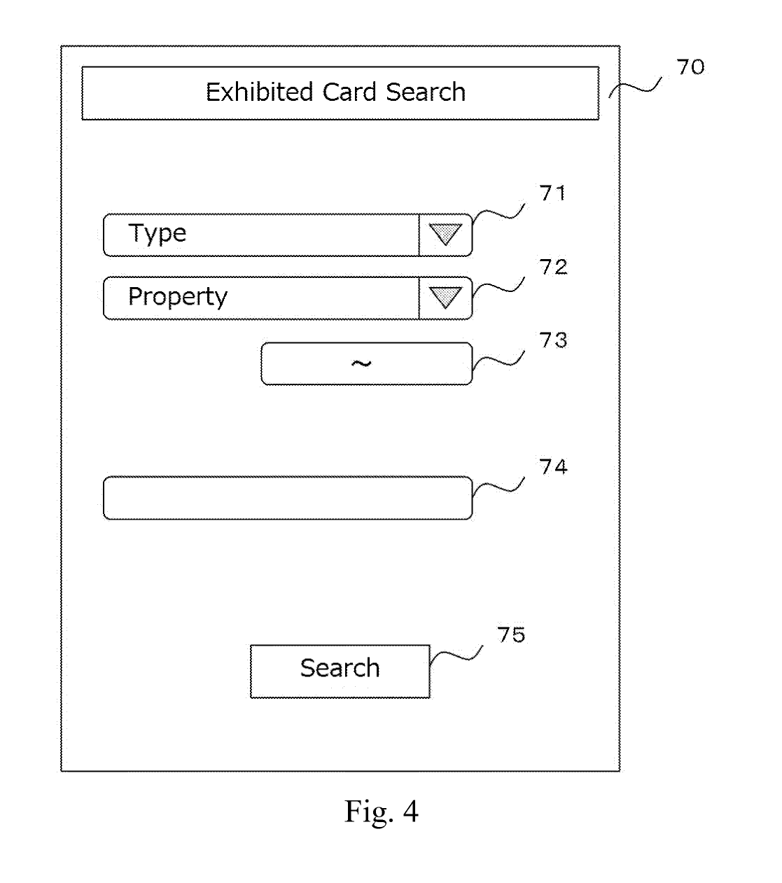

In an embodiment of the present invention, the exhibited item information may be generated in response to, for example, a display request from a user for information on an exhibited game item and a search request for exhibited game items satisfying a certain condition. For example, a user playing a game can obtain exhibited item information by searching for the exhibited game item through a search function provided as a function of the game. FIG. 4 shows an example of search screen for searching game items. For example, the user playing the game can cause the display screen shown in FIG. 4 to be displayed on a display screen of the client 30 by operating a link or operation button (not shown) captioned with “Exhibited Card Search” displayed in the game screen.

As shown, the search screen 70 contains pulldown boxes 71, 72 for designating search conditions, an input box 73 for designating a numeric range, an input box 74 for designating a search term, and a Search button 75 for running a search. For example, in a search screen 70 displayed during a game play, a user can operate the pulldown boxes 71, 72 to select from preset search conditions, input a numeric range and a search term to the input boxes 73, 84, and then operate the Search button 75, thereby sending a search request corresponding to the designated search conditions to the server 10. For example, the pulldown box 71 may provide options representing the types of game items such as “card,” “equipment,” and “avatar”; and the pulldown box 72 may provide options representing the properties of game items such as “offense power” “defense power” and “mobility.” The input box 73 may accept free input of the user (in this case, the user can desirably input numerals such as “1231” or text) or provide a limited number of options (e.g., 10-increment options ranging from 10 to 200 such as “10,” “20,” . . . “200”).

For example, the user can select “card” from the pulldown box 71, select “mobility” from the pulldown box 72, and input “100-200” to the input box 73 (or select “100-200” from the options provided by the input box 73), and then operate the Search button 75, thereby sending to the server 10 a search request for searching for “game items having mobility of ‘100-200’ and classified in the type of ‘card.’” In the server 10, the exhibited item presenting module 44 may refer to the exhibition request management table and the property management table and specify one or more exhibited game items satisfying the search conditions designated in the search request from among exhibited game items being exhibited. The exhibited item presenting module 44 may return the exhibited item information generated for the specified exhibited game item to the client 30 having sent the search request.

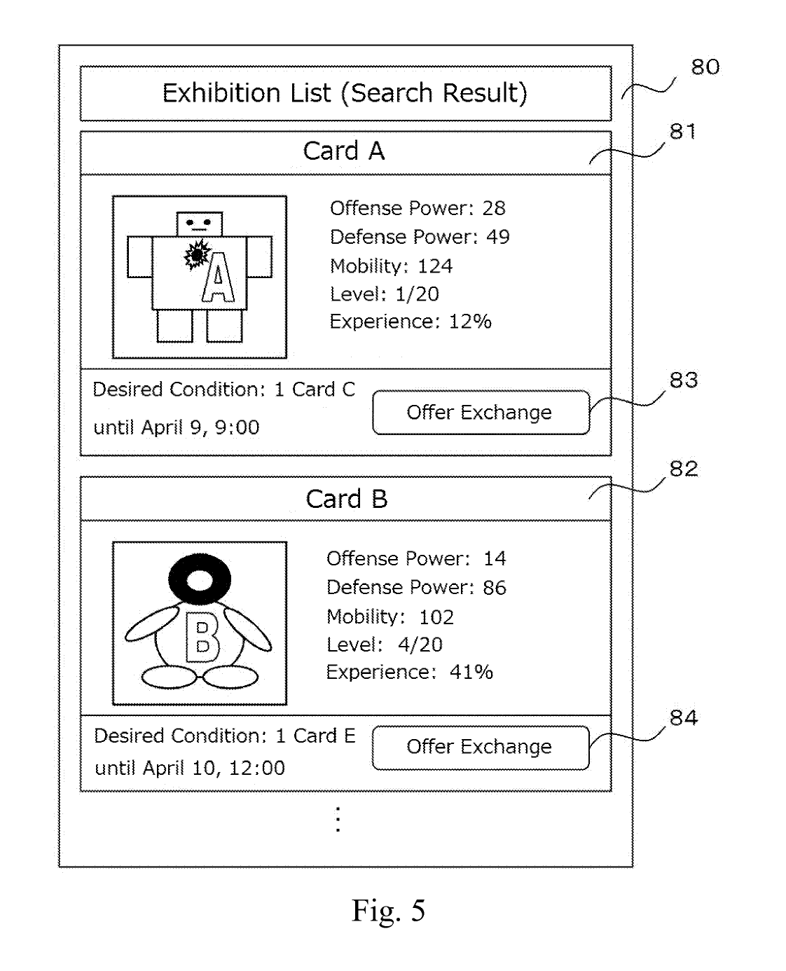

FIG. 5 shows an example of a search result returned from the server 10 and displayed on the client 30. More specifically, FIG. 5 shows an example of a search result for a search request for an exhibited “card,” which may include the exhibited item information representing the exhibited game items found by the search. The client 30 performing the game may receive the search result information from the server 10 and perform a drawing process such as rendering based on the received search result information to generate a display screen.

As shown in FIG. 5, the display screen 80 displayed on the client 30 may include the exhibited item image 81 and the exhibited item image 82. The exhibited item image 81 is an example of the image generated based on the exhibited item information with the exhibition request identifier “A000001” included in the search result information; and the exhibited item image 82 is an example of image generated based on the exhibited item information with the exhibition request identifier “A000002.” In the example shown in FIG. 5, both the exhibited item images 81, 82 include constant properties (e.g., item names “Card A” and “Card B”) and variable properties (e.g., “offense power” and “level”).

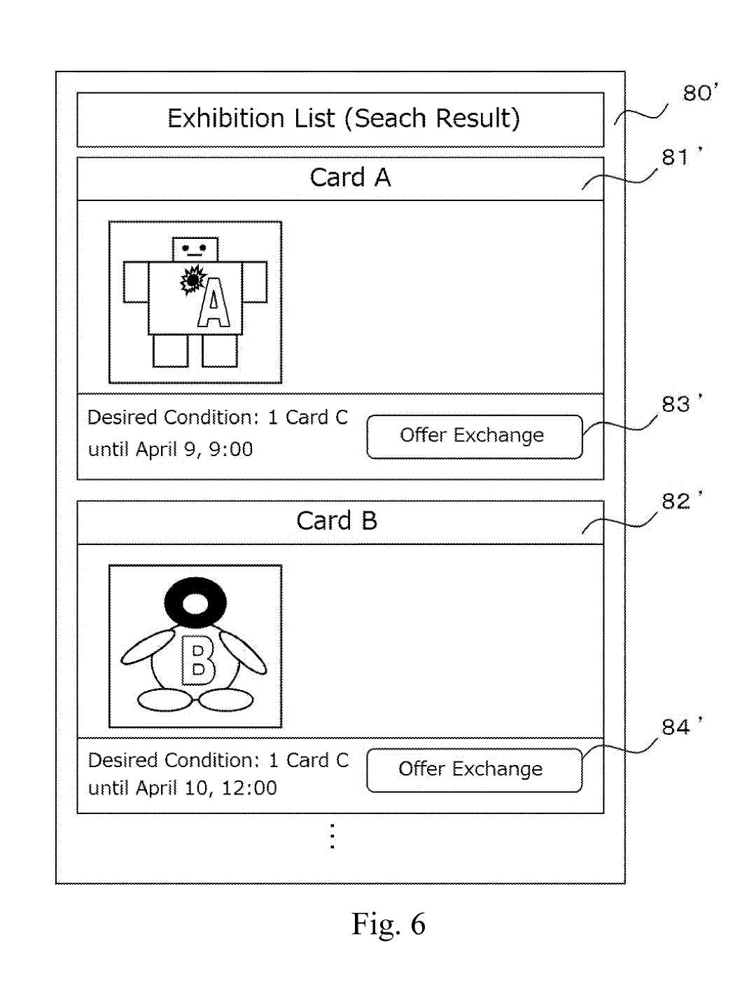

In an embodiment, the exhibited item information may be presented so as not to include the variable properties, as stated above. FIG. 6 shows an example of display of exhibited item information not including variable properties. In the display screen 80′ shown in FIG. 6, the exhibited item image 81′ may include the name “card A” of the exhibited game item associated with the exhibition request identifier “A000001” and the image representing the card A (both being constant properties), but may not include information such as level, offense power, defense power, and mobility (being variable properties). Likewise, the exhibited item image 82′ may also include the name and the image of the game item included in constant information but may not include variable property information such as level.

The exhibited item image may include various information based on the exhibited item information, in addition to the properties of the exhibited game item. For example, since the exhibition request management table shown in FIG. 3 may store the desired condition of “one” “item E” in association with the exhibition request identifier “A000001,” the exhibited item image 81 corresponding to the exhibition request identifier “A000001” may include the desired condition “Item E: 1” in the display area of the desired condition. Additionally, the generated exhibited item image may include the exhibition ending time stored in the exhibition request management table shown in FIG. 3, so that the exhibition period can be displayed as part of the exhibited item image. For example, since the exhibition request identifier “A000001” is associated with an exhibition period “April 9, 9:00,” the exhibited item image 81 may include the text “until April 9 9:00” in the display area of exhibition period. The display of the desired conditions and the exhibition period is optional; and the exhibited item image 81 and the exhibited item image 82 may not include the desired conditions or the exhibition period.

In the embodiments shown in FIGS. 5 and 6, the exhibition screens 80, 80′ may be generated so as not to include user specifying information for specifying the exhibiting user; therefore, the user who has searched the exhibited game items for exchange of game items cannot specify the exhibiting user of each exhibited game item. This may make it difficult to pay money in reality and prevent real money trade.

In the embodiment shown in FIG. 6, the exhibition screen 80′ may include none of the user specifying information and the variable properties; therefore, an exhibiting user cannot be specified from the variable properties. That is, when the exhibited item image includes information indicating the variable properties, the variable properties of the exhibited game item can be used as signs to specify the exhibiting user (e.g., when a user informs, through in-game messaging, another user that the user has exhibited a card with a mobility of “124,” the other user can specify the exhibiting user who has exhibited the game item with a mobility of “124”). In the embodiment shown in FIG. 6, the exhibited item information presented to the user is generated so as not to include the variable properties, which may make it more difficult to specify the exhibiting user and prevent real money trade more efficiently. Further, when an exhibiting user, not a user offering an exchange, views an exhibition screen related to an exhibited game item exhibited by the exhibiting user himself, the exhibition screen may contain variable properties and user specifying information that specifies the exhibiting user. That is, the variable properties and the user specifying information that specifies the exhibiting user of the exhibited game item may be hidden from users other than the exhibiting user of the exhibited game item, that is, users offering an exchange and users potentially offering an exchange.

On viewing the exhibition screen (e.g., the exhibition screen 80 shown in FIG. 5 and the exhibition screen 80′ shown in FIG. 6), a user can operate the client 30 to select an exhibited item image representing a desired game item from the exhibition screen, and send to the server 10 an exchange request for requesting exchange of the user's own game item for the selected game item. For example, when the user selects an operation button 83 captioned with “Offer Exchange” displayed as a part of the exhibited item image 81 in the exhibition screen 80 shown in FIG. 5, an exchange request may be sent to the server 10, the exchange request being made for exchanging the user's own game item for the exhibited game item corresponding to the exhibited item image 81. The user who performs operations to send an exchange request based on the display of the exhibition screen may be herein referred to as “an exchange offering user.” An exchange offering user may operate the operation button 84 instead of the operation button 83 if it is preferable to exchange for the exhibited game item corresponding to the exhibited item image 82.

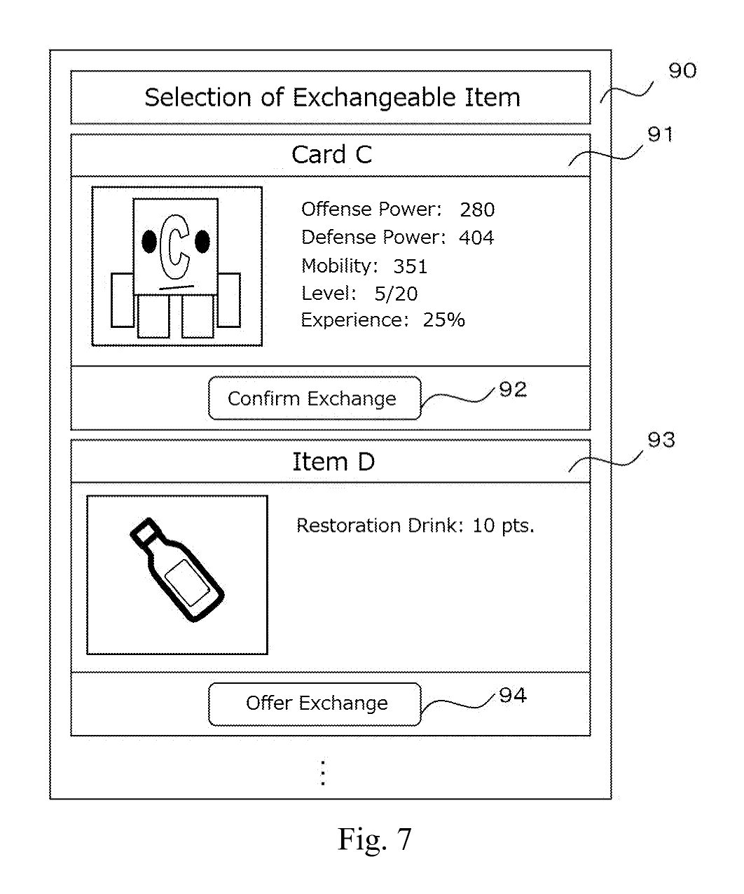

When the exchange offering user selects the operation button 83 captioned with “Offer Exchange” in the exhibition screen 80, the screen may transition to, e.g., the selection screen 90 of the exchangeable game items shown in FIG. 7. As shown in FIG. 7, the selection screen 90 of the exchangeable game items may display a list of game items (exchangeable game items) owned by the exchange offering user. For example, when user 2 is an exchange offering user, the selection screen 90 may include an exchangeable game item images 91, 93 representing the game items owned by the user 2 (a card C and a card D). Although the selection screen 90 shown in FIG. 7 only shows the two exchangeable game item images 91, 93, the selection screen 90 may display as many exchangeable game item images as the game items owned by the exchange offering user. The exchangeable game item images 91, 93 may include operation buttons 92, 94 captioned with “Confirm Exchange,” respectively. When the exchange offering user selects the operation button 92 or the operation button 94, an exchange request may be generated which includes the game item identifier of the exchangeable game item corresponding to the selected operation button, and the generated exchange request may be sent to the server 10 from the client 30 of the exchange offering user.

The exchange request thus sent from the client 30 to the server 10 may include the game item identifier identifying an exhibited game item desired, the game item identifier identifying an exchangeable game item to be exchanged for the exhibited game item, and the user identifier of the exchange offering user. For example, when user 2 offers an exchange of the game item (card C) owned by user 2 for the exhibited game item (card A) represented by the exhibited item image 81 included in the exhibition screen 80, the exchange request may include the game item identifier identifying the card A, the game item identifier identifying the card C, and the user identifier of user 2.

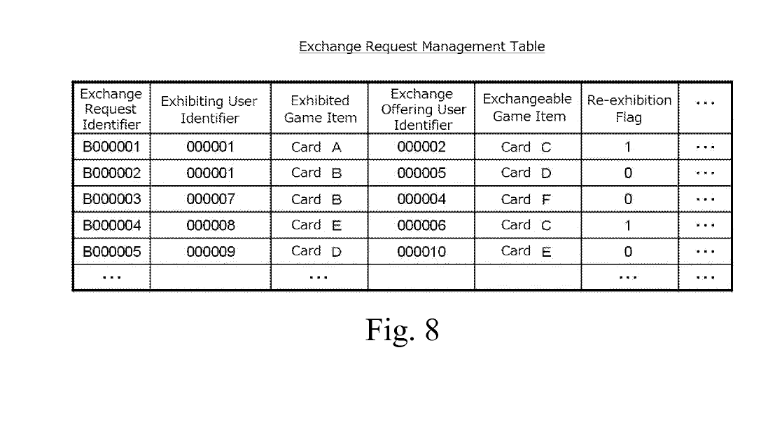

The exchange request sent from the client 30 of the exchange offering user may be received by the exchange request receiving module 45 in the server 10. When an exhibition period (or the time when the exhibition is to be ended) is assigned to the exhibited game item, the exchange request receiving module 45 may be configured to be able to receive an exchange request for the exhibited game item during the exhibition period only. The exchange request receiving module 45 may manage exchange requests from users using, e.g., an exchange request management table. FIG. 8 shows an example of exchange request management table used in the embodiment of the present invention. As shown, the exchange request management table may store, for each exchange request received by the exchange request receiving module 45, the exhibited game item and the exchangeable game item for which an exchange is requested by the exchange request, the user identifier of the exhibiting user having exhibited the exhibited game item, and the user identifier of the exchange offering user having sent the exchange request.

In an embodiment of the present invention, since an exchange request received by the exchange request receiving module 45 may be related to a real money trade, an exchange of game items in some cases may not be performed as designated by the exchange request. For example, when an exchange request is received by the exchange request receiving module 45, an exchange process of the exhibited game item and the exchangeable game item may not be performed as designated by the exchange request, but the re-exhibition information presenting module 46 according to an embodiment of the present invention may exhibit again (re-exhibit) the exchangeable game item in the exchange request as an exhibited game item. For example, when the exchange request receiving module 45 receives an exchange request for an exchange of an exhibited game item and an exchangeable game item, the re-exhibition information presenting module 46 may generate re-exhibition item information indicating that the exchangeable game item is exhibited for exchange for the exhibited game item.

The re-exhibition information presenting module 46 may generate re-exhibition item information with reference to, e.g., the exchange request management table shown in FIG. 8. More specifically, the re-exhibition information presenting module 46 may determine, based on the record of an exchange request specified by the exchange request identifier “B000001” in FIG. 8, that an exchange of card A (exhibited game item) exhibited from user 1 and card C (exchangeable game item) of user 2 is requested, generate re-exhibition item information for re-exhibiting card C designated as an exchangeable game item in the exchange request, and present the generated re-exhibition item information to the clients 30 of the users. It may also be possible that the re-exhibition item information should be presented to users other than the user who made the original exhibition request (that is, user 1 in the above example), not to all the users playing the game provided by the server 10. In an embodiment of the present invention, the re-exhibition item information may indicate that card C designated as an exchangeable game item in the original exchange request is exhibited from user 2 who is the exchange offering user in the exchange request, for exchange for card A designated as an exhibited game item in the exchange request.

As shown in FIG. 8, the exchange request management table may store a re-exhibition flag for each received exchange request. The re-exhibition information presenting module 46 according to an embodiment of the present invention may be configured to generate re-exhibition item information for only exchange requests having the re-exhibition flag set to “1.” For example, an exchange of card A of user 1 and card C of user 2 may not be performed based on the exchange request having the exchange request identifier of “B000001.” In contrast, as to an exchange request having the re-exhibition flag set to “0,” the re-exhibition item information may not be generated, but as will be described later, an exchange of game items may be performed based on the exchange request already received.

The exchange request receiving module 45 may set the re-exhibition flag of an received exchange request to “1” when, e.g., the properties of an exchangeable game item designated in the exchange request satisfy a predetermined condition. The predetermined condition may include a condition that the rarity value of the exchangeable game item should be equal to or greater than a predetermined value. The game provided by the server 10 may be designed such that game items having a higher rarity value are more difficult to obtain; therefore, a rarity value of an exchangeable game item equal to or greater than a predetermined value may indicate that the exchangeable game item is difficult to obtain. In typical real money trades, game items having a higher rarity value are obtained in exchange for money; therefore, the re-exhibition flag may be set to “1” when the rarity value of an exchangeable game item in an exchange request is equal to or greater than a predetermined value, so as to distinguish an exchange request probably related to a real money trade. When the rarity value of card C is equal to or greater than the predetermined value, the re-exhibition flag may be set to “1” in records in which an exchangeable game item is card C, as shown in FIG. 8. More specifically, the re-exhibition flag is set to “1” in exchange request records specified by the exchange request identifiers “B000001” and “B000004.”

The exchange request receiving module 45 according to another embodiment of the present invention may be configured to set the re-exhibition flag of a received exchange request to “1” when, e.g., the relationship between the properties of an exhibited game item and the properties of an exchangeable game item designated in the exchange request satisfy a predetermined condition. The predetermined condition may include a condition that the difference between the rarity value of the exhibited game item and the rarity value of the exchangeable game item should be equal to or greater than a predetermined value. When the difference between the rarity value of the exhibited game item and the rarity value of the exchangeable game item is equal to or greater than a predetermined value, it is indicated that a readily obtainable game item and a less obtainable game item are to be exchanged. This may probably be related to a real money trade. Since the re-exhibition flag of such an exchange request is set to “1,” the exchange request probably related to a real money trade can be distinguished.

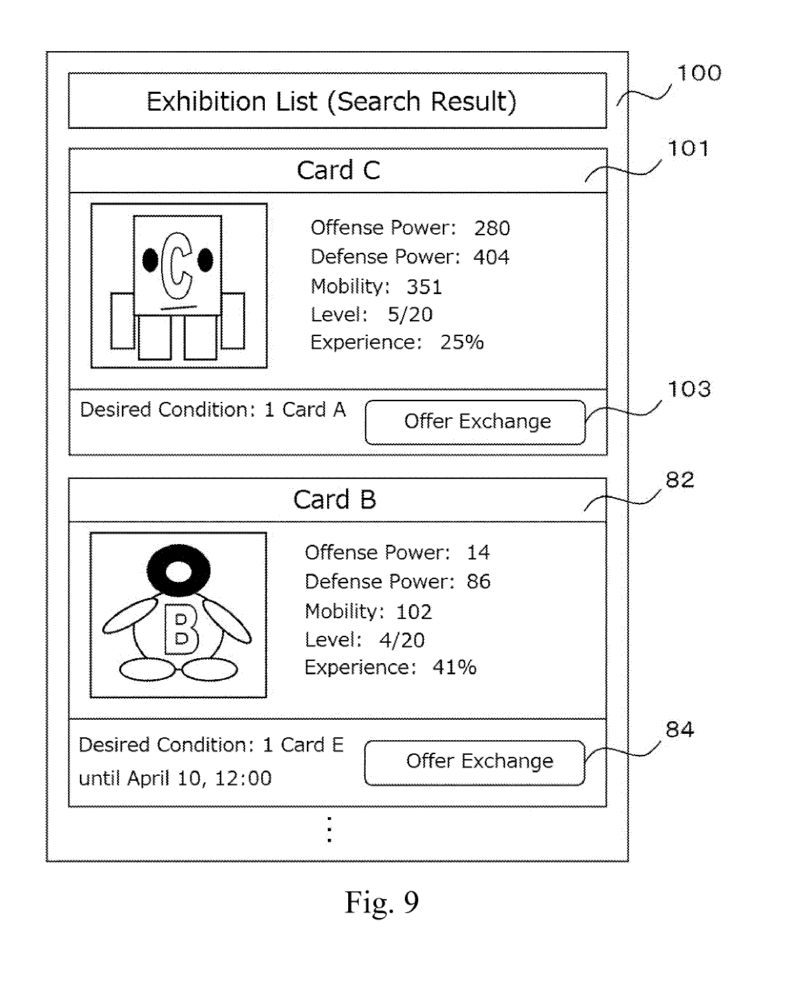

As with normal exhibited item information, the re-exhibition item information thus generated may be presented to the client 30 of a user in response to a display request received from the user for information on exhibited game items or a search request for exhibited game items satisfying a specific condition. FIG. 9 shows an example of a screen displaying a search result based on a search request for exhibited “cards,” as in FIGS. 5 and 6. This example is a screen displaying a search result when a search request is made after the re-exhibition information presenting module 46 generates the re-exhibition item information. As shown, the screen 100 displayed on the client 30 may include a re-exhibition item image 101 representing a re-exhibition item information, in addition to an exhibited item image 82 related to card B as shown in FIG. 5. The re-exhibition item image 101 may be generated based on the exchange request specified by the exchange request identifier “B000001” shown in FIG. 8 among the exchange requests received by the exchange request receiving module 45. The re-exhibition item image 101 may display an exchangeable game item (card C) specified by the exchange request identifier “B000001,” as an exhibited game item; and card C is exhibited for exchange for card A designated as an exhibited game item in the exchange request. Thus, in the re-exhibition item image 101, the exhibited game item and the exchangeable game item in the exchange request received by the exchange request receiving module 45 may be interchanged. That is, the exhibited game item in the exchange request may be displayed as a desired game item, while the exchangeable game item in the exchange request may be displayed as an exhibited game item.

In an embodiment of the present invention, the re-exhibition item image 101 may be presented to the user in priority to normal exhibited item images (that is, exhibited item images generated based on normal exhibition requests, not on re-exhibition). For example, as shown in FIG. 9, a re-exhibition item image 101 may be displayed in the top of the screen displaying a search result, in priority to other exhibited item images. The method of preferentially presenting a re-exhibition item image 101 to a user is not limited to that shown in FIG. 9. In the present invention, the re-exhibition item image 101 may be preferentially presented to a user by any method for presenting the image to the user such that the image is more conspicuous than normal exhibited item images. The method of preferentially presenting the re-exhibition item image 101 to a user may include, for example, highlighting a display region of the re-exhibition item image 101 with a conspicuous color or a decoration, displaying the re-exhibition item image 101 in a pop-up screen, and displaying the re-exhibition item image 101 in a larger size than normal exhibited item images.

A user viewing the exhibition screen 100 shown in FIG. 9 may operate the client 30 to select an exhibited game item represented by the re-exhibition item image 101 (which is the exchangeable game item in the original exchange request) from among the exhibited game items, and send to the server 10 an exchange request for exchange of his own game item for the selected game item. For example, when the user selects an operation button 103 captioned with “Offer Exchange” displayed as a part of the re-exhibition item image 101, an exchange request may be sent to the server 10, the exchange request being made for exchange for the exhibited game item corresponding to the re-exhibition item image 101. The method of generating an exchange request for a re-exhibition game item and the method of sending the exchange request to the server 10 may be the same as those for the normal exhibited game items (not re-exhibited). The exchange request generated based on the re-exhibition item image 101 may include an indicator indicating that the exchange request is for a re-exhibition game item (also herein referred to as “re-exhibition indicator”).

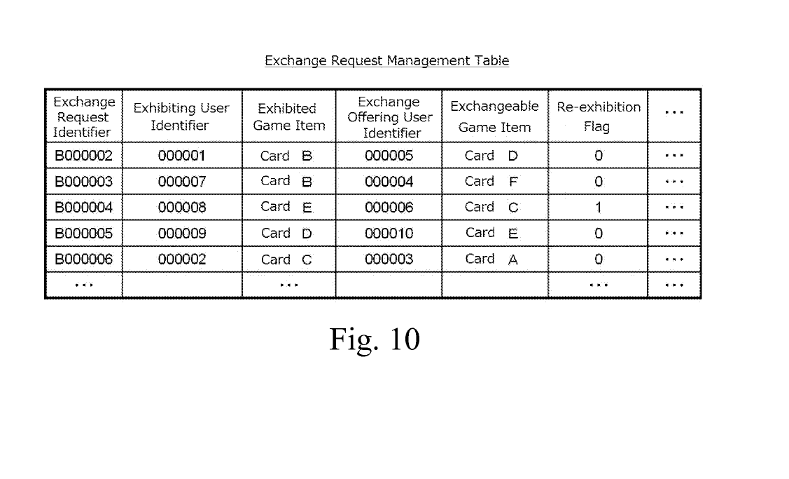

The exchange request thus generated based on the re-exhibition item image 101 may be received by the exchange request receiving module 45 in the server 10. The exchange request generated based on the re-exhibition item image 101 may also be managed as stated above using, e.g., the exchange request management table shown in FIG. 8. When the received exchange request includes a re-exhibition indicator, the exchange request management table may record a re-exhibition flag set to “0” in association with the exchange request identifier identifying the exchange request irrespective of the properties of the exhibited game item and the exchangeable game item designated in the exchange request. For example, on receiving from user 3 an exchange request for exchanging card C and card A generated based on the re-exhibition item image, the exchange request management table may record card C as an exhibited game item from user 2 and record card A as an exchangeable game item from user 3 in association with the exchange request identifier “B000006” identifying the exchange request as shown in FIG. 10. The exchange request specified by the exchange request identifier “B000001” in the exchange request management table shown in FIG. 8 may be deleted from the exchange request management table when re-exhibition item information is generated based on the exchange request.

The exchange module 47 according to an embodiment of the present invention may perform an exchange process for exchanging an exhibited game item and an exchangeable game item designated in an exchange request received by the exchange request receiving module 45. As stated above, the exchange request management table may record the exhibited game item and the exchangeable game item specified based on the exchange request received by the exchange request receiving module 45, in association with each other. Additionally, the exchange request management table may record a re-exhibition flag for each exchange request, which indicates whether an exchange process can be performed. An exchange request having the re-exhibition flag set to “1” may be treated not with an exchange process but with a process for presenting re-exhibition item information; on the other hand, an exchange request having the re-exhibition flag set to “0” may be treated with an exchange process for exchanging the exhibited game item and the exchangeable game item designated in the exchange request.

When an exhibition period (or the time when the exhibition is ended) is assigned to an exhibited game item, a plurality of exchange requests may be received within the exhibition period. Thus, when a plurality of exchange requests are received for one exhibited game item, an exchange process may be performed based on the exchange request designating the most favorable condition to the exhibiting user exhibiting the exhibited game item among the plurality of exchange requests. For example, when an exchange request designates an exchangeable game item having a higher rarity value than other exchange requests, or when an exchange request designates a larger number of exchangeable game items than other exchange requests, the exchange request may be determined to designate a more favorable condition than the other exchange requests.

In the embodiment shown in FIG. 10, an exchange process of an exhibited game item and an exchangeable game item may be performed based on an exchange request having the re-exhibition flag set to “0.” For example, an exchange of card B exhibited by user 1 and card D offered by user 5 may be performed based on the record with an exchange request identification number of “B000002.” Also, an exchange of card C of user 2 and card A of user 3 may be performed based on the record with an exchange request identification number of “B000006” generated based on re-exhibition item information. As shown in the exchange request management table shown in FIG. 8, user 2 has made an exchange request for exchanging card C for card A. It should be noted that the exchange of card C and card A is implemented with user 3, who has made an exchange request with respect to the re-exhibition request, not with user 1, who is the exhibitor of card A in the original exchange request. Thus, even if user 2 attempts to provide his own card C having a high rarity value to user 1 in exchange for real currency, user 2 cannot deliver card C, an object of the trade, to user 1 since card C is re-exhibited.

The exchange module 47 according to an embodiment of the present invention may perform an exchange process by, e.g., updating the owned item management table shown in FIG. 2. When card B of user 1 is exchanged for card D of user 5, the exchange module 47 may update the owned item management table so as to replace card B with card D in association with the user identifier “000001” of user 1 and replace card D with card B in association with the user identifier “000005” of user 5, thereby to perform the exchange process.

As stated above, an exhibition ending time may be assigned to an exhibited game item. When an exhibition ending time is assigned to an exhibited game item for which an exchange is requested, the exchange module 47 may perform an exchange process after the exhibition ending time. If a plurality of exchange requests have been made for the exhibited game item at the exhibition ending time of the exhibited game item, an exchange process may be performed on an exchange request selected from the plurality of exchange requests by lottery or performed on an exchange request designating the most favorable exchange condition. On the other hand, when no exhibition ending time is assigned to the exhibited game item, an exchange process may be performed based on an exchange request for the exhibited game item which is received first.

When re-exhibition item information is generated based on an exchange request from a user, the exchange process based on the exchange request may remain unfinished for a while. When re-exhibition item information is generated based on an exchange request (a first exchange request), the display control module 48 according to an embodiment of the present invention may present, to the user who has sent the original exchange request (the first exchange request), information indicating that the exchange request is in process, until another exchange request (a second exchange request) based on the re-exhibition item information is made and an exchange process based on the second exchange request is performed. For example, the display control module 48 may cause the client 30 of the user who has sent the original exchange request (the first exchange request) to display a message informing that the exchange request is in process.

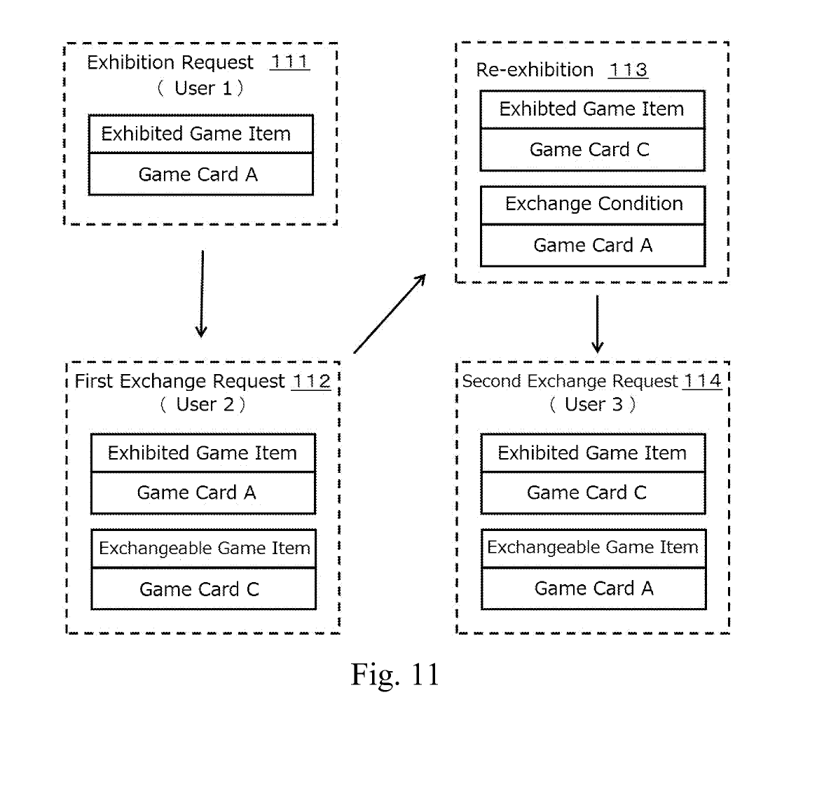

FIG. 11 schematically shows a process flow after a game item is exhibited until an exchange is performed. As shown, in the first step, user 1 may send an exhibition request 111 for exhibiting card A, and user 2 may send a first exchange request 112 for exchanging his own card C for card A exhibited. The re-exhibition information presenting module 46 may generate, based on the exchange request 112, re-exhibition item information 113 designating card C as an exhibited game item and indicating that card C is exhibited for exchange for card A, and present the generated re-exhibition item information 113 to the user. Among the users viewing the re-exhibition item information 113, user 3 may send to the server 10 a second exchange request 114 for exchanging his own card A for card C, which is the exhibited game item in the re-exhibition item information 113. The exchange module 47 may perform an exchange of card C of user 2 and card A of user 3 based on the second exchange request 114. Thus, even if user 2 attempts to exchange his own card C for card A of user 1, this exchange may not be concluded and card C may be re-exhibited as an exhibited game item in the case where the above predetermined condition is satisfied (e.g., the rarity of card C is equal to or greater than a predetermined value) (re-exhibition 113). Then, an exchange of card A and card C may be concluded with user 3 who has made the second exchange request 114 based on the re-exhibition item information. Thus, even if user 1 and user 2 previously agree on payment of real currency for exchange of card A and card C in the game, the exchange of card A and card C between user 1 and user 2 may not be concluded. Therefore, a real money trade can be prevented. Since user 2, who has sent the first exchange request 112, desires to exchange his own card C for card A, an exchange of cards may be concluded under the condition as desired by user 2 if the re-exhibition item information designates card A (the exhibited game item in the original exhibition request) as an exchange condition.

The program modules executed on the client 30 will be described below. The game module 61 according to an embodiment of the present invention may generate a game screen based on game data received from the server 10.

The display module 62 according to an embodiment of the present invention may be configured to cause a screen of the client 30 to display various information such as search results of exhibited game items and images representing re-exhibition item information received from the server 10.

The sending module 63 according to an embodiment of the present invention may be configured to send, to the server 10, command information indicating operation instructions from the user and various game data related to progress of the game.

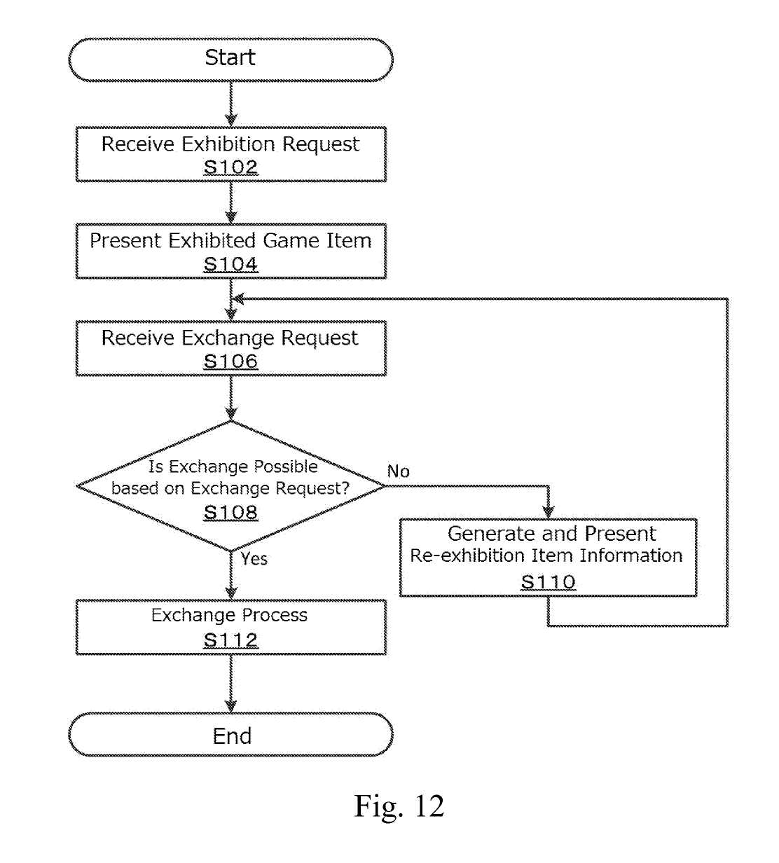

Next, a flow of exchanging game items will now be described in accordance with an embodiment of the present invention with reference to FIG. 12. First, a user (e.g., user 1) of an online game may send an exhibition request of his own game item (exhibited game item) to a server providing the online game; and in step S102, the exhibition request may be received by the server. The exhibition request may be received by, e.g., the exhibition request receiving module 43 described above. The information on the received exhibition request (the user identifier of the exhibiting user and the information identifying the exhibited game item) may be managed using, e.g., the exhibition request management table shown in FIG. 3 along with exhibition requests from other users.

Next, when a user of the online game (e.g., user 2) sends a search request for game items exhibited by the users of the online game, step S104 may be executed where the exhibited item information on the exhibited game items may be presented to the user who has made the search request. The exhibited item information may be presented to the user by, e.g., the exhibited item presenting module 44 described above. An example of exhibited item information presented to the user is shown in FIGS. 5 and 6.

Next, when the user who has obtained the exhibited item information sends an exchange request for exchanging his own game item for an exhibited game item, step S106 may be executed where the server may receive the exchange request. The exchange request may be received by, e.g., the exchange request receiving module 45 described above. The information on the received exchange request (information specifying the exhibited game item, information specifying the exchangeable game item, user identifier identifying the exhibiting user, the user identifier identifying the exchange offering user, etc.) may be managed using, e.g., the exhibition request management table shown in FIG. 8.

Next, step S108 may be executed where it is determined whether an exchange of game items can be performed based on the exchange request received in step S106. For example, when the rarity value of the exchangeable game item designated in the received exchange request is equal to or greater than a predetermined value (that is, when the rarity value of the exchangeable game item is higher than a predetermined degree), and when the difference in rarity value between the exhibited game item and the exchangeable game item is equal to or greater than a predetermined value (that is, when the difference in rarity value between the exchangeable game item and the exhibited game item is greater than a predetermined amount), the exchange of the exhibited game item and the exchangeable game item designated in the exchange request may not be performed, and step S110 may be executed where re-exhibition item information may be generated. In step S110, re-exhibition item information may be generated which indicates that the exchangeable game item in the exchange request for which an exchange process has been determined not to be performed is exhibited for exchange for the exhibited game item in the exchange request. That is, the re-exhibition item information is generated so as to designate the exchangeable game item in the original exchange request as an exhibited game item. The generated re-exhibition item information may be presented to a user (e.g., user 3) along with exhibition information of other exhibited game items when, e.g., the user makes a search request for exhibited game items. An example of display of the re-exhibition item information is shown in FIG. 9. After the re-exhibition item information is presented to the user, step S106 may be executed where it becomes possible to receive an exchange request for the exhibited game item specified by the re-exhibition item information (the exchangeable game item in the original exchange request).

If it is determined in step S108 that an exchange process based on an exchange request can be performed, step S112 may be executed where an exchange of the exhibited game item and the exchangeable game item in the exchange request may be performed. For example, upon an exchange request for the exhibited game item indicated by the re-exhibition item information (the exchangeable game item in the original exchange request), an exchange of the exhibited game item and the exchangeable game item may be performed in accordance with the exchange request. The exchange process of game items may be performed by, for example, the exchange module 47 described above.

As stated above, in some embodiments of the present invention, an exchange may not be concluded upon reception of a certain exchange request for an exhibited game item; and the exchangeable game item in such an exchange request may be re-exhibited as an exhibited game item, for which an exchange may be concluded upon reception of an exchange request for the re-exhibited game item. Particularly upon reception of an exchange request for an exhibited game item which is probably related to a real money trade (this is determined based on properties of the exhibited game item and the exchangeable game item such as rarity values), an exchange based on the exchange request may not be concluded and re-exhibition item information may be generated. Thus, a real money trade between users can be prevented. Additionally, since an exchange is concluded such that the user having made the original exchange request can obtain his desired game item, there is no need of canceling the exchange request or forcing an undesired exchange on the user.

In still another embodiment of the present invention, information on an exhibited game item may be presented to an exchange offering user so as not to include user specifying information that specifies the exhibiting user. This embodiment further inhibits the partner of exchange of game items in a game from being specified, thus effectively restraining real money trade.

The procedures described herein, particularly those described with a flowchart (FIG. 12), are susceptible of omission of part of the steps constituting the procedure, adding steps not explicitly included in the steps constituting the procedure, and/or reordering the steps. The procedure subjected to such omission, addition, or reordering is also included in the scope of the present invention unless diverged from the purport of the present invention.

The processes and procedures described and illustrated herein may be implemented by software, hardware, or any combination thereof, in addition to those explicitly stated in the embodiments. More specifically, the processes and procedures described and illustrated herein may be implemented by the installation of the logic corresponding to the processes into a medium such as an integrated circuit, a volatile memory, a non-volatile memory, a magnetic disk, or an optical storage. The processes and procedures described and illustrated herein may also be installed in the form of a computer program, and executed by various computers.

Even if the processes and the procedures described herein are executed by a single apparatus, software piece, component, or module, such processes and procedures may also be executed by a plurality of apparatuses, software pieces, components, and/or modules. Even if the data, tables, or databases described herein are stored in a single memory, such data, tables, or databases may also be dispersed and stored in a plurality of memories included in a single apparatus or in a plurality of memories dispersed and arranged in a plurality of apparatuses. The elements of the software and the hardware described herein can be integrated into fewer constituent elements or can be decomposed into more constituent elements.

What is claimed is:

1. A system comprising one or more computer processors configured to execute a computer program to provide a game capable of being played by a plurality of users,
wherein the computer program comprises:
an exhibition request receiving module configured to receive, from a first user among the plurality of users, an exhibition request for exhibiting a first game item owned by the first user;
an exchange request receiving module configured to receive, from a second user among the plurality of users, an exchange request for exchanging a second game item owned by the second user for the first game item exhibited by the first user; and
a re-exhibition information presenting module configured to present, to part or all of the plurality of users, re-exhibition item information indicating that the second game item is exhibited for exchange for the first game item.

2. The system of claim 1 wherein the computer program further comprises an exchange module configured to perform, upon receiving from a third user among the plurality of users an exchange request for exchanging the first game item owned by the third user for the second game item presented by the re-exhibition information presenting module, an exchange of the second game item owned by the second user and the first game item owned by the third user.

3. The system of claim 1 wherein the re-exhibition information presenting module presents the re-exhibition item information when a rarity value of the second game item in the exchange request satisfies a predetermined condition.

4. The system of claim 1 wherein the re-exhibition information presenting module presents the re-exhibition item information when a relationship between a rarity value of the first game item and a rarity value of the second game item in the exchange request satisfies a predetermined condition.

5. The system of claim 1 wherein the re-exhibition information presenting module presents the re-exhibition item information to the plurality of users other than the first user.

6. The system of claim 1 wherein the computer program further comprises an exhibited item presenting module configured to present, to each of the plurality of users, exhibited item information on an exhibited game item exhibited by the other user.

7. The system of claim 6 wherein the re-exhibition information presenting module presents the re-exhibition item information in priority to the exhibited item information.

8. The system of claim 6 wherein the exhibited item presenting module presents the exhibited item information so as not to include variable properties varying in accordance with progress of the game among properties of the exhibited game item.

9. The system of claim 6 wherein the exhibited item presenting module presents the exhibited item information so as not to include user specifying information specifying a user exhibiting the exhibited game item.

10. The system of claim 1 wherein the computer program further comprises a display control module configured to display, to the second user, information indicating that the exchange request is in process, until an exchange is performed between the second user and the third user by the exchange module.

11. The system of claim 2 wherein
the exchange request receiving module is configured to receive from the third user an exchange request for exchanging the first game item owned by the third user for the second game item presented by the re-exhibition information presenting module, and receive from a fourth user among the plurality of users an exchange request for exchanging the first game item owned by the fourth user for the second game item presented by the re-exhibition information presenting module; and
the exchange module performs an exchange of the second game item owned by the second user and the first game item owned by the third user when an exchange condition specified by the exchange request from the third user is more favorable to the second user than an exchange condition specified by the exchange request from the fourth user.

12. The system of claim 11 wherein the exchange request receiving module is configured to receive exchange requests from the third user and the fourth user within a predetermined period after the re-exhibition item information is presented by the re-exhibition information presenting module.

13. A computer-readable storage medium storing a program for providing a game capable of being played by a plurality of players, the program causing one or more computer processors to function as:
an exhibition request receiving unit configured to receive, from a first user among the plurality of users, an exhibition request for exhibiting a first game item owned by the first user;
an exchange request receiving unit configured to receive, from a second user among the plurality of users, an exchange request for exchanging a second game item owned by the second user for the first game item exhibited by the first user; and
a re-exhibition information presenting unit configured to present, to part or all of the plurality of users, re-exhibition item information indicating that the second game item is exhibited for exchange for the first game item.

14. A method of providing a game capable of being played by a plurality of users, the method comprising the steps of:
receiving, from a first user among the plurality of users, an exhibition request for exhibiting a first game item owned by the first user;
receiving, from a second user among the plurality of users, an exchange request for exchanging a second game item owned by the second user for the first game item exhibited by the first user; and
presenting, to part or all of the plurality of users, re-exhibition item information indicating that the second game item is exhibited for exchange for the first game item.
